(19) United States
(12) Patent Application Publication
(10) Pub. No.: US 2021/0258332 A1
(43) Pub. Date: Aug. 19, 2021

(54) APPARATUS AND METHOD FOR PROVIDING CYBER SECURITY TRAINING CONTENT

(71) Applicant: DUDU Information Technologies, Inc., Seoul (KR)

(72) Inventors: Su Man NAM, Gyeonggi-do (KR); Young Sun PARK, Seoul (KR)

(21) Appl. No.: 17/127,212

(22) Filed: Dec. 18, 2020

(30) Foreign Application Priority Data
Feb. 14, 2020 (KR) 10-2020-0018499

(51) Int. Cl. H04L 29/06; H04L 29/08; G06F 9/455; G06F 16/955

(52) U.S. Cl. CPC H04L 63/1425; H04L 67/141; G06F 2009/45587; G06F 16/9558; G06F 2009/45595; G06F 9/45558

(57) ABSTRACT

A method for providing a cyber security simulation training content by a server, includes: receiving from a client terminal, a connection link call request of a virtual machine (VM) corresponding to at least one cyber security simulation training content; selecting, by the virtualization connection unit, VM information corresponding to the connection link call request of the VM from a database (DB) of the WAS; transmitting the VM information selected from the DB to a daemon module of the WAS; requesting a first VM link from a virtualization management unit of the virtualization element using the VM information; generating the first VM link by the virtualization management unit and transmitting the generated first VM link to the daemon module; obtaining a second VM link from the DB using the first VM link; and providing information on the second VM link to the client terminal.

### CROSS-REFERENCE TO RELATED APPLICATION

This application claims priority to Korean Patent Application No. 10-2020-0018499, Feb. 14, 2020 and all the benefits accruing therefrom under 35 U.S.C. § 119, the contents of which are incorporated by reference in their entirety.

### BACKGROUND

The following description relates to an apparatus and method for providing a cyber security simulation training content. In more detail, the following description relates to a technology in which a server provides a virtual machine image related to the cyber security simulation training content by using a virtual machine. A technology for stably managing a virtual machine for a cyber security simulation training content by restricting a client from directly accessing the virtual machine and indirectly providing only an image of the virtual machine corresponding to the cyber security simulation training content is disclosed.

As can be seen from news that virtual currency exchanges in Korea have been hacked, the risk of cyber terrorism is increasing worldwide. Accordingly, the need for a cyber security training system that trains users to cope with potential threats together with education on cyber security is also increasing.

In order to train real users, a simulation technique that attempts cyber attacks on specific networks and observes behavior changes of the users coping with the cyber attacks is required. Training programs for large-scale cyber terrorism include an Internet attack simulator (IAS) that simulates denial of service attacks, unauthorized access and spoofing, and the like.

In the related art, in order to develop human resources who protect networks from the cyber attacks, a virtual environment including virtual machines or virtual networks has been constructed, and practices have been made in a state in which trainees are divided into an attacking side and a defensing side. For example, according to Boeing's cyber range-in-a-box (CRIAB), a large-scale virtual environment may be constructed, and a plurality of trainees may team up to practice the cyber attacks using the virtual environment. Further, by allowing such a virtual environment to access a real server or an external network, a more realistic practice environment may be provided.

Japanese Patent No. 5905512 provides a cyber attack practice system, a practice environment provision method, and a practice environment provision program. A content that a server establishes a virtual network, in which host groups and hosts used for practice are connected to each other, in each practice terminal that practices cyber attacks is disclosed. Further, the existing patent discloses a port control unit that prevents an influence on an external network by shutting down a physical port based on an instruction input from an instructor terminal 30 when an abnormality occurs in a practice environment.

However, the existing patent does not disclose, imply, or suggest a configuration in which a WAS transmits, to a virtualization element, information corresponding to a connection link call request of a VM, the virtualization element returns a first VM link to the WAS, and the WAS returns a second VM link corresponding to the first VM link and transmits the second VM link to a client terminal.

### SUMMARY OF THE INVENTION

According to at least one embodiment, a method of providing a cyber security simulation training content by providing an image of a VM to a client terminal by a server including a WAS and a virtualization element is disclosed. According to at least one embodiment, an apparatus and method in which the server provides the image of the VM using a first VM link used in an internal private network, and provides, to the client terminal, a second VM link corresponding to the first VM link and capable of being used in the outside, and thus the client terminal may call the VM is disclosed.

According to an aspect, a method of providing a cyber security simulation training content by a server is disclosed.

The server may implement a virtualization element for driving a web application server (hereinafter, referred to as WAS) and a plurality of virtual machines.

In accordance with an exemplary embodiment of the present invention, a method includes: receiving, by a virtualization connection unit of the WAS, from a client terminal, a connection link call request of a virtual machine (hereinafter, referred to as VM) corresponding to at least one cyber security simulation training content; selecting, by the virtualization connection unit, VM information corresponding to the connection link call request of the VM from a database (hereinafter, referred to as DB) of the WAS; transmitting, by the virtualization connection unit, the VM information selected from the DB to a daemon module of the WAS; requesting, by the daemon module, a first VM link from a virtualization management unit of the virtualization element using the VM information; generating the first VM link by the virtualization management unit and transmitting the generated first VM link to the daemon module;

obtaining, by the daemon module, a second VM link corresponding to the first VM link from the DB using the first VM link; and providing, by the daemon module, information on the second VM link to the client terminal.

The connection link call request of the VM may include identification information on the at least one cyber security simulation training content and login information of a client, and the VM information may include information on an original text name of the VM corresponding to the identification information of the at least one cyber security simulation training content and an allocation number identified by the login information of the client and allocated to the client.

The DB may store the information on the original text name of the VM and the allocation number allocated to the client, the original text name of the VM may be allocated to each of a plurality of the VMs supported by the virtualization element, and the allocation number may be allocated differently according to the original text name of the VM and the identification information of the client.

The method may further include receiving, by a router comprised in the server, from the client terminal, the call request of the VM using the second VM link; converting, by the router, the second VM link into the first VM link corresponding to the second VM link; and receiving, by the virtualization element, the first VM link from the router and providing, to the client terminal, an image of a VM connectable by the first VM link.

The connection link call request of the VM further may include information on a connection session formed between the client terminal and the server, the WAS may transmit, to the virtualization element, information corresponding to the call request of the VM when the login information of the client is authenticated, the second VM link may include a portion in which the information on the connection session is encrypted, and the virtualization element may provide the image of the VM to the client terminal only when it is identified that the client terminal is connected to the connection session.

### BRIEF DESCRIPTION OF THE DRAWINGS

Exemplary embodiments can be understood in more detail from the following description taken in conjunction with the accompanying drawings, in which:

FIG. 1 is a block diagram illustrating a configuration of a server according to an exemplary embodiment;

FIG. 2 is a conceptual view illustrating a cyber security simulation training content providing system according to the exemplary embodiment;

FIG. 3 is a conceptual view illustrating the cyber security simulation training content providing system illustrated in FIG. 2 in more detail;

FIG. 4 is a conceptual view illustrating an exemplary schema of a DB;

FIG. 5 is a flowchart illustrating a cyber security simulation training content providing method according to the exemplary embodiment;

FIG. 6 is a flowchart illustrating a next part of the flowchart illustrated in FIG. 5;

FIG. 7 is a conceptual view for describing an exemplary configuration of a first VM link; and

FIG. 8 is a conceptual view for describing an exemplary configuration of a second VM link.

### DETAILED DESCRIPTION OF PREFERRED EMBODIMENTS

Specific structural or functional descriptions of embodiments are disclosed for illustrative purposes, and may be changed and implemented in various forms. Thus, the embodiments are not limited to a specific disclosure, and the scope of the present specification includes changes, equivalents, or substitutes included in the technical spirit.

Although terms such as first and second may be used to describe various components, these terms should be interpreted only to distinguish one component from other components. For example, a first component may be referred to as a second component, and similarly, the second component may be referred to as the first component.

When it is referenced that a first component is “connected” to a second component, it should be understood that the first component may be directly connected or coupled to the second component or a third component may be present between the first component and the second component.

Singular expressions include plural expressions unless clearly otherwise indicated in the context. It should be understood in the present specification that terms such as “include” or “have” are intended to indicate that there are features, numbers, steps, operations, components, parts, or combinations thereof that are described, and do not exclude in advance the possibility of the presence or addition of one or more other features, numbers, steps, operations, components, parts, or combinations thereof.

Unless otherwise defined, all terms used herein including technical or scientific terms have the same meanings as those commonly understood by those skilled in the corresponding art. Terms defined in commonly used dictionaries should be interpreted as having the same meanings in the context of the related art, and may not be interpreted with ideal or excessively formal meanings, unless explicitly defined in the present specification.

Hereinafter, embodiments will be described in detail with reference to the accompanying drawings. In the description with reference to the accompanying drawings, the same components are designated by the same reference numerals regardless of the reference numerals, and the duplicated description thereof will be omitted.

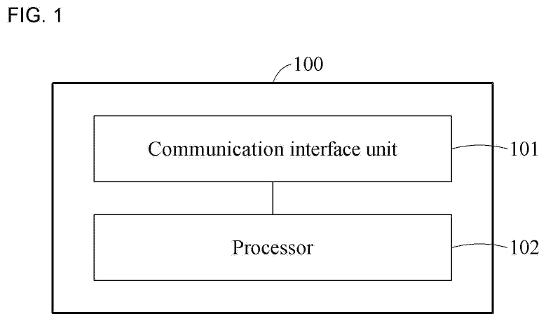

FIG. 1 is a block diagram illustrating a configuration of a server 100 according to an exemplary embodiment.

Referring to FIG. 1, the server 100 may include a communication interface unit 101 and a processor 102.

The communication interface unit 101 may operate under control of the processor 102. The communication interface unit 101 may transmit a signal in a wireless communication manner or a wired communication manner according to a command of the processor 102. In addition, in a broad sense, the communication interface unit 101 may include a keyboard, a mouse, other external input devices, a printer, a display, and other external output devices for receiving commands or instructions.

The processor 102 may execute a program command stored in a memory and/or a storage device. The processor 102 may mean a central processing unit (CPU), a graphics processing unit (GPU), or a dedicated processor configured to perform methods according to the present invention. The memory and the storage device may be configured as a volatile storage medium and/or a non-volatile storage medium. For example, the memory may be configured as a read-only memory (ROM) and/or a random access memory (RAM).

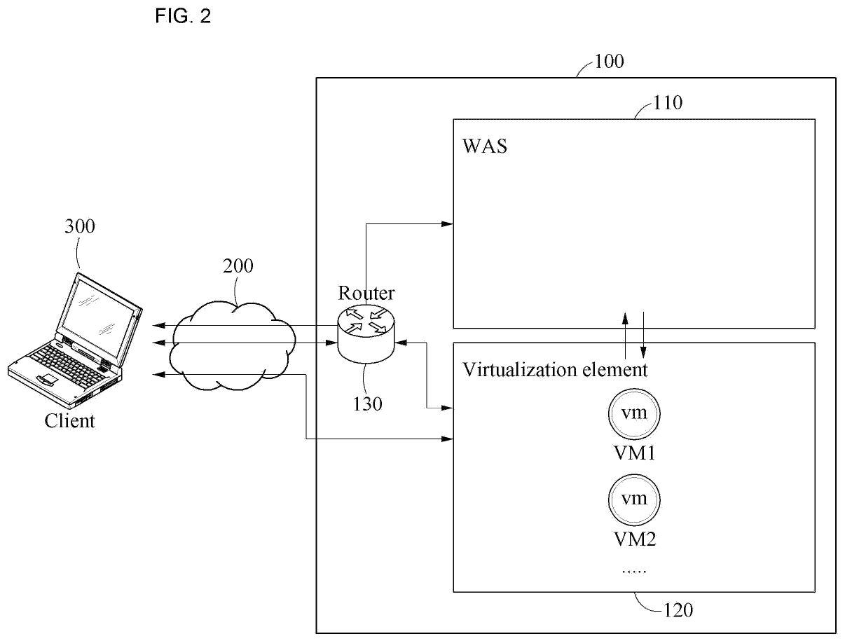

FIG. 2 is a conceptual view illustrating a cyber security simulation training content providing system according to the exemplary embodiment.

Referring to FIG. 2, the cyber security simulation training content providing system may include a server 100, a network 200, and a client terminal 300. The server 100 may be operated by a provider that provides a cyber security simulation training content or a subject supervised by the provider. However, the embodiments are not limited thereto. The server 100 may achieve desired system performance using a typical combination of computer hardware (for example, devices that may include a computer processor, a memory, a storage device, an input device and an output device, and other components of conventional computing devices; electronic communications device such as a router and a switch; and electronic information storage systems such as a storage network-attached storage (NAS) device and a storage area network (SAN) device) and computer software (that is, commands that cause a computing device to be functioned in a specific manner).

The server 100 may implement a web application server (WAS) 110, a router 130, and a virtualization element 120. Although the WAS 110, the virtualization element 120, and the router 130 are separately illustrated in different blocks in FIG. 1, the above-described configurations are not limited to being strictly separated physically or logically.

The WAS 110 may be a software framework that provides a function of implementing and operating a web application and a server environment. The WAS 1110 may provide a dynamic server content and perform a predetermined calculation function using information stored in a database. The virtualization element 120 may access a virtual machine (VM) based on a request of a client and display an image of the VM on a browser of the client terminal 300. The virtualization element 120 may include virtualization hardware computing resources that may drive a plurality of the VMs. The virtualization element 120 may be associated with physical hardware by at least one of VMware, ESXI, Microsoft Hyper-V, and OpenStack. However, the embodiments are not limited to the above-described example.

The VMs provided by the virtualization element 120 may provide different virtual environments, respectively. The client may perform cyber security simulation training using virtual environments provided by the VMs. That is, the virtual environments provided by the VMs may correspond to cyber security simulation training environments.

The router 130 may receive a predetermined link from the client terminal 300. The router 130 may perform port forwarding to convert the predetermined link received from the client terminal 300 into a different link. The router 130 may transmit the converted link to the virtualization element 120. The virtualization element 120 may provide a specific image of the VM to the client terminal 300 using the converted link.

The network 200 may include a wired network, a wireless network, and the like as a network connecting the server 100 and the client terminal 300. The network 200 may be a closed network such as a local area network (LAN) and a wide area network (WAN) or an open network such as the Internet. The Internet means a worldwide open computer network structure that provides a TCP/IP protocol and various services existing in an upper layer thereof, that is, a hypertext transfer protocol (HTTP), Telnet, a file transfer protocol (FTP), a domain name system (DNS), a simple mail transfer protocol (SMTP), a simple network management protocol (SNMP), a network file service (NFS), and a network information service (NIS).

The client terminal 300 may be a user's device that may access the network 200. The client terminal 300 may include a smart phone, a tablet personal computer (PC), a laptop, a desktop, and the like, but is not limited thereto. The client terminal 300 may display a user interface. The client terminal 300 may transmit user interaction information about the user interface to the server 100.

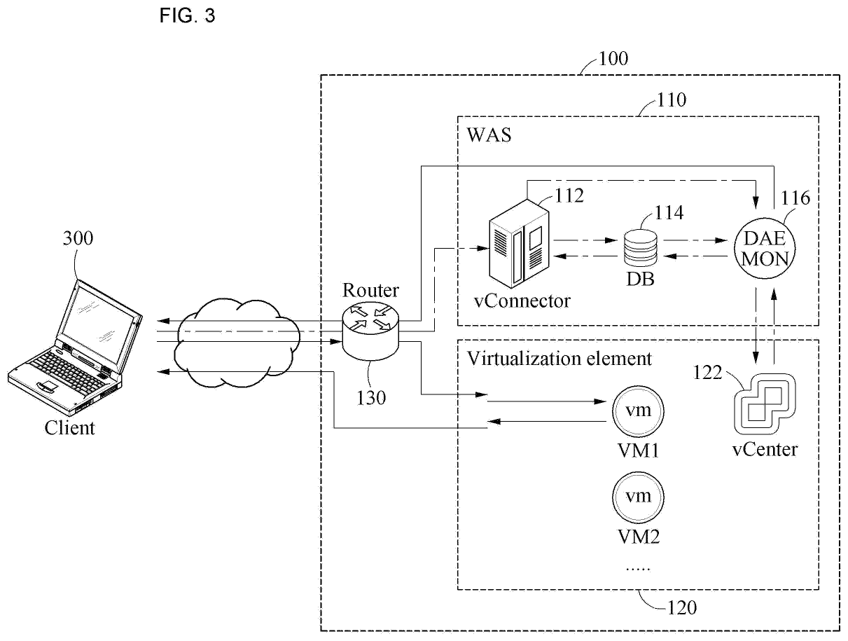

FIG. 3 is a conceptual view illustrating the cyber security simulation training content providing system illustrated in FIG. 2 in more detail.

Detailed configurations illustrated in FIG. 3 are merely illustrated separately in units of performed functions, and are not intended to limit that the detailed configurations should be strictly separated physically or logically. Referring to FIG. 3, the WAS 110 may include a virtualization connection unit 112, a database (hereinafter, DB) 114, and a daemon module 116. The virtualization connection unit 112 may receive, from the client terminal 300, a request of a VM access link corresponding to a training content desired by the client. The virtualization connection unit 112 may access the DB 114 to authenticate login information of the client included in the request of the VM access link. When the login information is completely authenticated, the virtualization connection unit 112 may select VM information in the DB 114. The virtualization connection unit 112 may transmit the VM information to the daemon module 116.

The daemon module 116 may perform various tasks while being driven in a background without being directly controlled by the user. The daemon module 116 may request a first VM link from a virtualization management unit 122 of the virtualization element 120 using the VM information acquired by the virtualization connection unit 112. The virtualization management unit 122 may provide the first VM link to the daemon module 116. The daemon module 116 may access the DB 114 to acquire a second VM link corresponding to the first VM link and provide the second VM link to the client terminal 300. When the client terminal 300 transmits a call request of the VM using the second VM link, the router 130 may convert the second VM link into the first VM link to perform port forwarding. The virtualization element 120 may cause the image of the VM corresponding to the first VM link to be displayed on the browser of the client terminal 300.

The first VM link may be used to access the VM inside the server 100. The first VM link may not be exposed to the outside. The second VM link port-forwarded to the first VM link may be provided to the client terminal 300. Thus, the client terminal 300 may be prevented from directly accessing the VM of the virtualization element 120 using the first VM link. Through this, the client terminal 300 may be prevented from deleting or modifying the VM or hacking the VM.

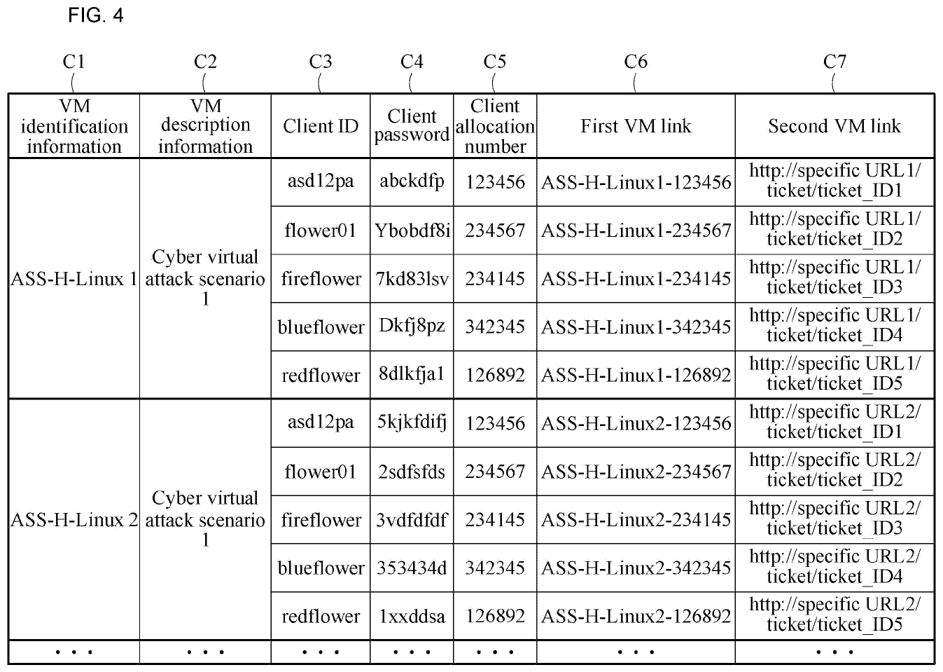

FIG. 4 is a conceptual view illustrating an exemplary schema of the DB 114.

Referring to FIG. 4, identification information of the VM may be stored in a C1 column of the DB 114. For example, an original text name of the VM may be stored in the C1 column. Description information on the purpose of the VM may be stored in a C2 column. Login ID information of the client who has permission to use the VM may be stored in a C3 column. Password information of the client may be stored in a C4 column. The virtualization connection unit 112 may authenticate login of the client using the login information stored in the C3 column and the C4 column.

An allocation number allocated to each client for each VM may be stored in a C5 column. The client allocation number stored in the C5 column may be used to configure the first VM link as described below. The client allocation number may not be exposed to the outside of the server 100. Thus, the client terminal 300 may be restricted from acquiring information on the client allocation number. Information on the first VM link used to access the VM inside the server 100 may be stored in a C6 column. The first VM link may be set differently for each client based on the client allocation number allocated to the client. The second VM link provided to the client terminal 300 may be stored in a C7 column. The daemon module 116 may acquire the second VM link corresponding to the first VM link by loading the information in the C6 column and the C7 column of the DB 114, and provide the acquired information to the client terminal 300.

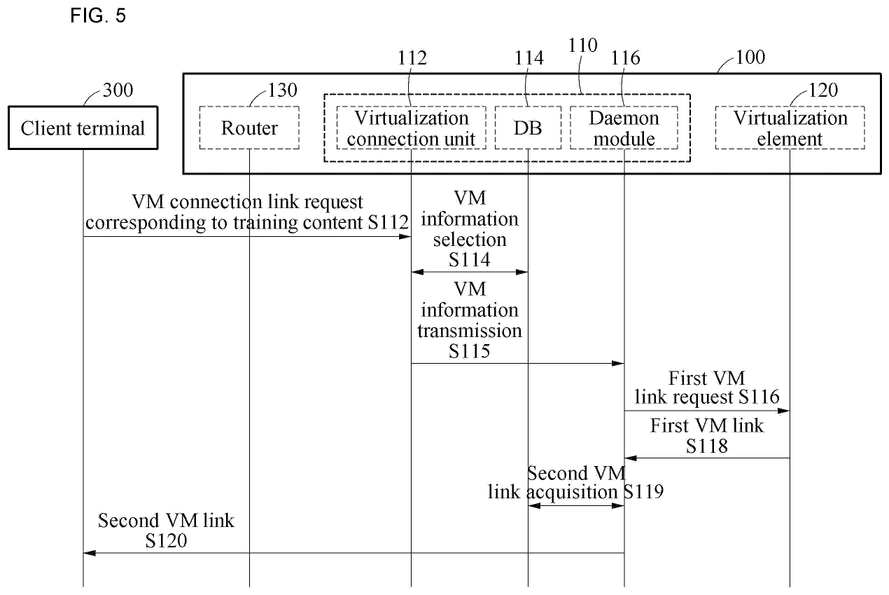

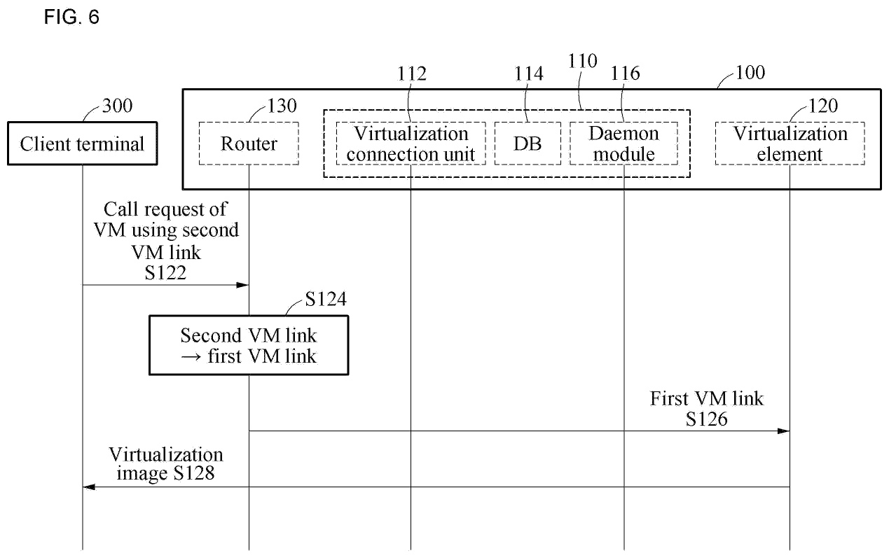

FIG. 5 is a flowchart illustrating a cyber security simulation training content providing method according to the exemplary embodiment. FIG. 6 is a flowchart illustrating a next part of the flowchart illustrated in FIG. 5.

In step S112, the client terminal 300 may transmit, to the server 100, a VM access link request corresponding to at least one training content. The WAS 110 of the server 100 may receive the VM access link request. The virtualization management unit 122 of the WAS 110 may process the corresponding request. The VM access link request may include the login information of the client and information on the VM desired by the client. For example, the VM access link request may include an ID of the client, a password of the client, and VM original text information required by the client.

In step S114, the virtualization connection unit 112 of the WAS 110 may access the DB 114. The virtualization connection unit 112 may select, from the DB 114, the VM information corresponding to the VM access link request. For example, the virtualization connection unit 112 may select the VM original text information corresponding to the training content desired by the client.

In step S115, the virtualization connection unit 112 may transmit the selected VM information to the daemon module 116. The daemon module 116 may acquire the VM information from the virtualization connection unit 112.

In step S116, the WAS 110 may transmit the VM information to the virtualization element 120. For example, the daemon module 116 may transmit the VM information to the virtualization management unit 122 and request the first VM link.

In step 118, the virtualization element 120 may return the first VM link to the daemon module 116 of the WAS 110. The virtualization connection unit 112 may generate the first VM link using the VM information acquired by the daemon module 116 and the client allocation number and return the generated first VM link to the daemon module 116.

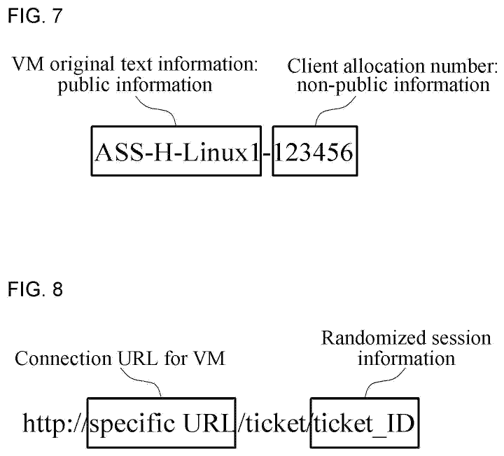

FIG. 7 is a conceptual view for describing an exemplary configuration of a first VM link.

Referring to FIG. 7, the first VM link may be determined by the VM original text information and the client allocation number. Among them, the VM original text information, which is information shared between the server 100 and the client terminal 300, may be used to identify the VM corresponding to the training content desired by the client. The client allocation number may be non-disclosure information that is not disclosed to the client terminal 300. Thus, the client terminal 300 may be restricted from acquiring information on the first VM link that may directly access the VM inside the server 100.

Referring back to FIGS. 5 and 6, in step S120, the daemon module 116 of the WAS 110 may select, from the DB 114, the second VM link corresponding to the first VM link based on the first VM link. The daemon module 116 of the WAS 100 may provide the second VM link to the client terminal 300.

FIG. 8 is a conceptual view for describing an exemplary configuration of a second VM link.

Referring to FIG. 8, the second VM link may include a uniform resource locator (URL) for identifying the access to the VM corresponding to the training content desired by the client and randomized session information. The second VM link may be disclosed to the client terminal 300. However, the second VM link is converted into the first VM link by port forwarding which will be described below, direct access to the VM is restricted with only the second VM link, and thus the client terminal 300 may be prevented from hacking the VM.

The randomized session information may be information obtained by randomizing information on a connection session formed between the client terminal 300 and the server 100. The virtualization element 120 may compare the session information randomized in the second VM link transmitted from the client terminal 300 and the session information formed between the client terminal 300 and the server 100 and may provide the image of the VM only when the two information correspond to each other. When a validated period of the session formed between the client terminal 300 and the server 100 has expired, the previously distributed second VM link may no longer be valid. Thus, even when information on the second VM link is stolen by a terminal that does not have the right to use the image of the VM, the validated period of the session connection is short, and thus the use of the image of the VM by the terminal that does not have the use right may be restricted.

Referring back to FIGS. 5 and 6, in step S122, the client terminal 300 may transmit, using the second VM link, a call request for the VM corresponding to at least one cyber security simulation training content.

In step S124, the router 130 of the server 100 may convert the second VM link into the first VM link by the port forwarding.

In step S126, the router 130 may request the image of the VM from the virtualization element 120 using the first VM link.

In step S128, the virtualization element 120 may provide the image of the VM corresponding to the first VM link to the client terminal 300. The client terminal 300 may display the image of the VM on the browser.

Hereinabove, the cyber security simulation training content providing method and apparatus according to the exemplary embodiment has been described with reference to FIGS. 1 to 8. According to at least one embodiment, the cyber security simulation training environment may be provided to the client using the VM. According to at least one embodiment, only the second VM link that may not directly access the VM is provided to the client terminal, and thus the VM may be prevented from being hacked by the client terminal. According to at least one embodiment, the router of the server may provide the image of the VM to the client terminal by converting the second VM link into the first VM link by port forwarding. According to at least one embodiment, since the second VM link includes the randomized session information, even when the second VM link is stolen by a terminal not having the right to use the VM, the use of the VM by an unauthorized terminal may be prevented.

The above-described embodiments may be implemented as a hardware component, a software component, and/or a combination of the hardware component and the software component. For example, the devices, the methods, and the component described in the embodiments may be implemented using one or more general-purpose computers or special-purpose computers such as a processor, a controller, an arithmetic logic unit (ALU), a digital signal processor, a microcomputer, a field programmable gate array (FPGA), a programmable logic unit (PLU), a microprocessor, and any other devices that may execute and respond to an instruction. A processing device may perform an operating system (OS) and one or more software applications performed on the OS. Further, the processing device may access, store, operate, process, and generate data in response to execution of software. For convenience of understanding, it is described that one processing device is used. However, those skilled in the art may know that the processing device may include a plurality of processing elements and/or a plurality of types of processing elements. For example, the processing device may include a plurality of processors or one processor and one controller. Further, the processing device may be other processing configurations such as a parallel processor.

The software may include a computer program, a code, an instruction, or a combination of one or more thereof, and may configure the processing device to be operated as desired or may independently or collectively command the processing device. The software and/or the data may be permanently or temporarily embodied in any type of machine, a component, physical equipment, virtual equipment, a computer storage medium or device, or a transmitted signal wave to be interpreted by the processing device or to provide the instruction or the data to the processing device. The software may be distributed over a networked computer system and stored or executed in a distributed manner. The software and the data may be stored in one or more computer-readable recording media.

A method according to the embodiment may be implemented in the form of program instructions that may be performed through various computer units and recorded in the computer-readable medium. The computer-readable medium may include program instructions, data files, data structures, and the like alone or in combination. The program instructions recorded in the computer-readable medium may be specially designed and configured for the embodiments or may be known and usable to those skilled in the computer software. Example of the computer-readable recording medium include magnetic media such as hard disks, floppy disks, and magnetic tapes, optical media such as compact disc read-only memories (CD-ROMs) and digital versatile discs (DVDs), magneto-optical media such as floptical disks, and hardware devices, such as read-only memories (ROMs), random access memories (RAMs), and flash memories, that are specially configured to store and execute program instructions. Examples of the program instructions include not only machine language codes such as those produced by a compiler but also high-level language codes that may be executed by a computer using an interpreter or the like. The above-described hardware device may be configured to be operated as one or more software modules to perform the operation of the embodiments, and vice versa.

As described above, although the embodiments have been described with reference to the limited drawings, various modifications and changes may be made based on the above description by those skilled in the art. For example, even though the described technologies are performed in an order different from the described method, and/or the described components such as a system, a structure, a device, and a circuit are coupled or combined in a form different from the described method or are replaced or substituted by other components or equivalents, appropriate results may be achieved.

What is claimed is:

1. A method for providing a cyber security simulation training content, in which a server for providing a cyber security simulation training content implements a virtualization element for operating a web application server (hereinafter, referred to as WAS) and a plurality of virtual machines, the method comprising:
receiving, by a virtualization connection unit of the WAS, from a client terminal, a connection link call request of a virtual machine (hereinafter, referred to as VM) corresponding to at least one cyber security simulation training content;
selecting, by the virtualization connection unit, VM information corresponding to the connection link call request of the VM from a database (hereinafter, referred to as DB) of the WAS;
transmitting, by the virtualization connection unit, the VM information selected from the DB to a daemon module of the WAS;
requesting, by the daemon module, a first VM link from a virtualization management unit of the virtualization element using the VM information;
generating the first VM link by the virtualization management unit and transmitting the generated first VM link to the daemon module;
obtaining, by the daemon module, a second VM link corresponding to the first VM link from the DB using the first VM link; and
providing, by the daemon module, information on the second VM link to the client terminal.

2. The method of claim 1, wherein
the connection link call request of the VM comprises identification information on the at least one cyber security simulation training content and login information of a client, and
the VM information comprises information on an original text name of the VM corresponding to the identification information of the at least one cyber security simulation training content and an allocation number identified by the login information of the client and allocated to the client.

3. The method of claim 2, wherein
the DB stores the information on the original text name of the VM and the allocation number allocated to the client,
the original text name of the VM is allocated to each of a plurality of the VMs supported by the virtualization element, and
the allocation number is allocated differently according to the original text name of the VM and the identification information of the client.

4. The method of claim 3, further comprising:
receiving, by a router comprised in the server, from the client terminal, the call request of the VM using the second VM link;
converting, by the router, the second VM link into the first VM link corresponding to the second VM link; and
receiving, by the virtualization element, the first VM link from the router and providing, to the client terminal, an image of a VM connectable by the first VM link.

5. The method of claim 4, wherein
the connection link call request of the VM further comprises information on a connection session formed between the client terminal and the server,
the WAS transmits, to the virtualization element, information corresponding to the call request of the VM when the login information of the client is authenticated,
the second VM link comprises a portion in which the information on the connection session is encrypted, and
the virtualization element provides the image of the VM to the client terminal only when it is identified that the client terminal is connected to the connection session.
